(19) United States
(12) Patent Application Publication
(10) Pub. No.: US 2025/0315534 A1
(43) Pub. Date: Oct. 9, 2025

(54) Method and module for detecting security vulnerabilities in a computer farm

(71) Applicant: ORANGE, ISSY LES MOULINEAUX (FR)

(72) Inventors: Maxime Belair, Chatillon (FR); Sylvie Laniepce, Chatillon (FR); Adam Ouorou, Chatillon (FR)

(21) Appl. No.: 18/866,252

(22) PCT Filed: Apr. 23, 2023
(86) PCT No.: PCT/EP2023/060555

§ 371 Date: Nov. 15, 2024

(30) Foreign Application Priority Data
May 16, 2022 (FR) FR2204607

(51) Int. Cl. G06F 21/57; H04L 9/40

(52) U.S. Cl. CPC G06F 21/577; H04L 63/1433

(57) ABSTRACT

A detection method implemented by a computer for detecting exploitability of a computer vulnerability in a set of processes associated with a namespace combination. The method including, for a reference process of the set, steps of: initializing, from the reference process, and executing a test process associated with the combination and executing a detection program, the execution of the program producing an indicator of the exploitability of the vulnerability in the set of processes; and sending to a security management device at least one signal including the indicator.

### PRIOR ART

The invention relates to the general field of securing the computer programs.

The invention more particularly aims a method for managing the computer security of a computer equipment infrastructure using programs for detecting computer vulnerabilities.

It is recalled that the term vulnerability designates a flaw in a computer process, this flaw allowing, if exploited, overriding security rules of the computer system on which the program of this process is executed. For example, the vulnerability CVE-2021-44228 called “Log4Shell” is present in the logging software component Log4J. The component Log4J is used by many applications using the Java language. This vulnerability allows a remote attacker in the most severe cases to have an arbitrary code executed by the target machine. A technical means that allows an attacker to exploit this vulnerability is called attack vector. Such a technical means is for example an instruction in a computer program.

Such a vulnerability, in order to be exploited, requires the presence of software and/or hardware resources or means with weaknesses. For example, the exploitation of a vulnerability can correspond to the sending of instructions on a particular server. If a process does not have resources allowing such sending, then this vulnerability cannot be exploited in this process. Conversely, the process can have such resources, in which case the vulnerability is exploitable provided that no security program blocks the attacks aimed at exploiting this vulnerability.

The term process designates an inner representation of a program running in the memory of the computer. Each time a program is executed, one or more processes are created.

As known, security flaws are listed in a public list accessible at https://www.cve.org/in May 2022, each vulnerability referenced in the list being identified by a unique CVE (for Common Vulnerabilities and Exposures) identifier.

Thousands of CVE identifiers are issued each year, and a complex software can be affected by hundreds of CVEs.

The management of CVEs for maintaining the security of a stock of computer equipment can therefore be excessively complex.

The state of the art does not allow satisfactorily establishing or identifying the exploitable flaws that may compromise the security of the computers.

### DISCLOSURE OF THE INVENTION

The invention aims to facilitate the management of the security of a stock of computers by detecting the exploitable computer vulnerabilities on these computers. Corollarily, the invention makes it possible to strengthen the security of a computer stock.

As explained below, the invention proposes to evaluate the exploitability of the vulnerabilities at the level of the namespace combinations.

In the context of the invention, “namespaces” hereinafter refers to kernel-level namespaces of an operating system.

It is recalled that a namespace isolates, in an abstraction, an instance of a global system resource for the processes associated with this namespace. The modifications made to the system resource in a namespace are applied to all the processes associated with this namespace, but are invisible to all the other processes. The namespaces therefore offer a resource isolation mechanism.

As known, the Linux operating system proposes several namespaces (for example: Network, IPC (for Inter Process Communication), PID (for Process IDentifier), User, etc.) to isolate sets of processes.

More specifically, and according to a first aspect, the invention relates to a detection method implemented by a computer for detecting the exploitability of a computer vulnerability in a set of processes associated with a namespace combination, said method including, for a reference process of said set, steps of:
initializing, from the reference process, and executing a test process associated with said combination and executing a detection program, the execution of said program producing an indicator of the exploitability of said vulnerability in said set of processes;
sending to a security management device at least one signal comprising said indicator.

Correlatively, the invention proposes a detection module in a computer for detecting the exploitability of a computer vulnerability in a set of processes associated with a namespace combination, said module including, for a reference process of said set:
a submodule for initializing, from the reference process, and executing a test process associated with said combination and executing a detection program, the execution of said program producing an indicator of the exploitability of said vulnerability in said set of processes;
a submodule for sending, to a security management device, at least one signal comprising said indicator.

Thus, the invention makes it possible to identify the processes on which computer vulnerabilities can be exploited. Particularly, the method makes it possible to identify the processes with weaknesses that allow these vulnerabilities to be exploited. Such weaknesses result, for example, from particular software or hardware resources.

In this application, the namespace combination associated with a process refers to the set of the namespaces associated with this process. For example, in a Linux system, a process can be associated with a namespace combination currently containing (in May 2022) 9 namespaces of distinct types.

Subsequently, the expressions “process associated with a namespace combination” and “process in a namespace combination” will be used interchangeably.

Each namespace combination of the computer can be identified automatically. The method advantageously makes it possible to determine an indicator of the exploitability of a vulnerability in an identified combination, without having to test this exploitability for each process in this namespace combination.

To detect the exploitability of a vulnerability (in particular a CVE vulnerability) in a namespace combination, the invention proposes to use a single process in this combination. This process is called reference process of the combination since it is used to initialize a test process making it possible to implement the detection of exploitability in this combination. The test process is for example created as a process identical to the reference process. By initialization of a process is meant here the creation followed by the triggering of the execution of this process.

The test process has access to the same resources assigned by the namespace combination as all the other processes in this combination. In addition, the test process inherits, at the time of its creation, the environment variables of the reference process.

In one particular mode of implementation of the detection method, said reference process is the basic process of said combination.

In this application, the term “basic process of the combination” designates the first process created in this combination.

The term “environment variables” designates types of values that can be used by processes. In particular, these values can give access to some resources. For example, on a Linux system, the environment variable <PATH> corresponds to the list of the directory(ies) in which executable files are situated. For example, a first set of processes is associated with the same value of the variable <PATH>, which will allow these processes to use the executable files located by this value without using the absolute paths towards these files. In this same example, a second set of processes is associated with a different value of the variable <PATH>. The first and second sets of processes will therefore not have access to the same executable files.

Hereinafter, the expressions “environment variables of a process” and “values of the environment variables of a process” will be used interchangeably, for the sake of simplicity.

However, although at the time of its creation, a given process of a namespace combination generally inherits the environment variables of the basic process of this combination, the environment variables associated with this given process can change during its life.

But the invention proposes to disregard this possible change, and to consider as an approximation, that if a vulnerability is exploitable with the environment variables of a process of a namespace combination (hereinafter, such a vulnerability will be designated as being exploitable in this process), then this vulnerability is exploitable with the environment variables of any process of the same namespace combination, including if these environment variables have changed during the life of this process.

Conversely, the invention proposes to consider as an approximation that if a vulnerability is not exploitable with the environment variables of a process of a namespace combination, then this vulnerability is not exploitable with the environment variables of any process of the same namespace combination.

The inventors have found that changes to environment variables associated with a process during its life were uncommon, and generally did not affect the exploitability of said vulnerability.

Thus, the detection, by the test process, of the exploitability of the vulnerability is a reliable indicator of the actual exploitability of the vulnerability in the namespace combination.

The test process executes a program for detecting the exploitability of the vulnerability. The information generated by the execution of the detection program indicates the exploitability of the vulnerability in the namespace combination. This information, in the form of an indicator, is sent back to a security management device and in particular allows the user of this device to choose the appropriate security programs to be installed.

This indicator comprises at least one data making it possible to identify the vulnerability, for example an identifier of this vulnerability.

In one embodiment of the invention, the security management device is a server. Thus, the invention can be implemented by a plurality of computers in a computer stock, each of these computers being able to send back, to the security management server, the information on the exploitability of a vulnerability in their respective namespace combinations.

In this case, the security management server can be controlled by a central administrator who has a role of orchestration of the security on the computer stock.

Thus, this embodiment of the detection method makes it possible to automatically and centrally identify which security programs to install and where to install them. It is meant by security program a program whose execution prevents the exploitation of a computer vulnerability.

The invention also allows the central administrator to avoid the need to manually consult each administrator of each computer so that each of them, for example, manually and locally checks whether a vulnerability is present in the software of their machine, and if necessary whether measures have been taken to make it harmless.

According to one embodiment of the detection method, the execution of the detection program includes:
a determination of the presence of one or more means for exploiting said vulnerability in an environment defined by at least said namespace combination and the environment variables of said reference process;
and, if one or more said exploitation means are detected:
a test of exploitation of said vulnerability with this or these exploitation means.

In this embodiment, the evaluation, by the detection program, of the exploitability of the computer vulnerability is performed in two stages.

In a first determination step, it is determined whether the resource(s) necessary for the exploitation of the computer vulnerability are present in the environment of the process. The environment of a process includes the hardware and software resources accessible to the process in order to execute a program. In this case, it is defined at a minimum by the namespace combination and by the environment variables with which this process is associated.

If this determination step does not result in the detection of any means for exploiting the computer vulnerability, this means that the vulnerability is considered, due to the approximation mentioned above, as not present and therefore not exploitable in the namespace combination in which the detection program is executed.

However, if the presence of such means is detected, this does not necessarily imply that the vulnerability is actually exploitable. In particular, security programs can prevent the exploitation of the vulnerability.

Thus, in a second step, it is tested whether the vulnerability is actually exploitable. This step can for example correspond to the execution of an attack vector targeting said vulnerability. If this attack vector is consumed, this means that the vulnerability is exploitable. Otherwise, the vulnerability is not exploitable.

In other words, in this example, a test attack is executed. The success or failure of this test attack determines whether the computer vulnerability is exploitable or not.

In one particular embodiment, the detection method includes steps of:
receiving, from said security management device, an identifier of said vulnerability;
installing, in said computer, said detection program corresponding to said identifier.

Thus, the invention makes it possible to manage the selection of the computer vulnerabilities to be detected with the security management device.

In the case where the security management device is a server connected to a computer stock, executions of the detection programs on each computer can then be managed centrally, without requiring the contribution of the administrators of at least some computers of the stock, which makes it possible to avoid the manual installation of detection programs on at least some, for example on all the machines of the stock.

Furthermore, according to one embodiment of the method, the steps of initializing a test process and sending a signal to the security management device are carried out for several reference processes respectively associated with several namespace combinations.

Consequently, the detection method can advantageously be carried out in parallel for the set of namespace combinations of one or more computers, and thus ensure the security of the set of processes of this or these computers.

In one particular mode of implementation of the detection method, the step of installing the detection program includes sub-steps of:
sending, to a security server, a request including said identifier of the vulnerability;
receiving, in response to the request, said detection program.

This use of a security server advantageously makes it possible to save memory space on the computer.

This embodiment also makes it possible to provide the computer with a database including a plurality of programs for detecting the exploitability of computer vulnerability that can be installed as needed, upon decision of the security management server.

Advantageously, this outer database can be updated independently of the administrators of the computers of the stock.

In one particular embodiment of the detection method, said at least one signal further includes:
an identifier of said computer; and
a data representative of said at least one combination.

These data allow in particular a central administrator to map computer vulnerabilities and their exploitability.

According to one embodiment of the invention, the detection method is characterized in that said computer comprises a program for protection against the exploitation of said vulnerability and in that said protection program is neutralized during the execution of said detection program.

This embodiment makes it possible to more accurately evaluate the vulnerabilities on the computer. Particularly, it makes it possible to test whether a given protection program effectively protects against the exploitation of a given computer vulnerability.

If several protection programs are installed, this also makes it possible to identify the ineffective protection programs.

According to a second aspect, the invention proposes an identification method implemented by a security management device, to identify the exploitability of a computer vulnerability in at least one computer, said method including steps of:
receiving, from said at least one computer, a signal comprising an indicator of the exploitability of said vulnerability in a set of processes associated with a namespace combination of said at least one computer;
adding said signal to a list.

Correlatively, the invention proposes an identification module in a security management device, for identifying the exploitability of a computer vulnerability in at least one computer, said module including:
a submodule for receiving, from said at least one computer, a signal comprising an indicator of the exploitability of said vulnerability in a set of processes associated with a namespace combination of said at least one computer;
a submodule for adding said signal to a list.

The invention proposes a method for identifying, from a device (for example a server), a given computer vulnerability in a computer or a computer stock, as well as the namespace combinations in which this vulnerability is exploitable.

The steps of the identification method described above can be repeated for a plurality of given computer vulnerabilities.

This identification of computer vulnerabilities and their exploitability advantageously makes it possible to facilitate the orchestration of security on the computer stock by a central administrator controlling the security management device.

To this end, the invention proposes to pool the messages coming from the computers in which one or more exploitable vulnerabilities have been detected, by adding these messages to a list.

This list in particular allows the administrator to make decisions concerning the management of security in the computer stock. For example, the presence of some vulnerabilities in particular namespaces may encourage the installation of the security programs to strengthen the security of the processes associated with these namespaces.

According to one embodiment of the invention, the identification method includes a step of sending, to said at least one computer, an identifier of said vulnerability.

This sending allows the administrator of the security management device to decide which detection programs will be executed on the computers of the computer stock. Indeed, this embodiment allows, in one embodiment of the detection method described above, installing and executing the detection program in response to the sending of the vulnerability identifier by the security management device.

Each of the methods described above can be implemented by a computer program.

Consequently, the invention also relates to a computer program on a recording medium, this program being capable of being implemented in a computer device or more generally in a computer. This program includes instructions for implementing a method as described above.

This program can use any programming language, and be in the form of source code, object code, or intermediate code between source code and object code, such as in a partially compiled form, or in any other desirable form.

The invention also relates to an information medium or a recording medium readable by a computer and/or a computer device, and including instructions of a computer program as mentioned above.

The information or recording medium can be any entity or device capable of storing the programs. For example, the media can include a storage means, such as a ROM, for example a CD ROM or a microelectronic circuit ROM, or a magnetic recording means, for example a hard disk, or a flash memory.

On the other hand, the information or recording medium can be a transmissible medium such as an electrical or optical signal, which can be conveyed via an electrical or optical cable, by radio link, by wireless optical link or by other means.

The program according to the invention can be particularly downloaded from a network such as the Internet.

Alternatively, the information or recording medium can be an integrated circuit in which a program is incorporated, the circuit being adapted to execute or to be used in the execution of one of the methods as described above.

### BRIEF DESCRIPTION OF THE ANNEXES AND THE FIGURES

Other characteristics and advantages of the present invention will emerge from the description given below, with reference to the annexed drawings which illustrate one exemplary embodiment thereof without any limitation.

On the annexes:
[Annex. 1] The Annex 1 represents a first part of a detection program that can be used in one particular embodiment;
[Annex. 2] The Annex 2 represents a second part of a detection program that can be used in one particular embodiment;
In the figures:

FIG. 1 represents detection and identification devices in accordance with one particular embodiment;

FIG. 2 represents in the form of a flowchart the main steps of detection and identification methods that can be implemented in one particular embodiment;

FIG. 3 represents the functional architecture of a detection module in accordance with one particular embodiment of the invention;

FIG. 4 represents the functional architecture of an identification module in accordance with one particular embodiment of the invention.

### DETAILED DESCRIPTION

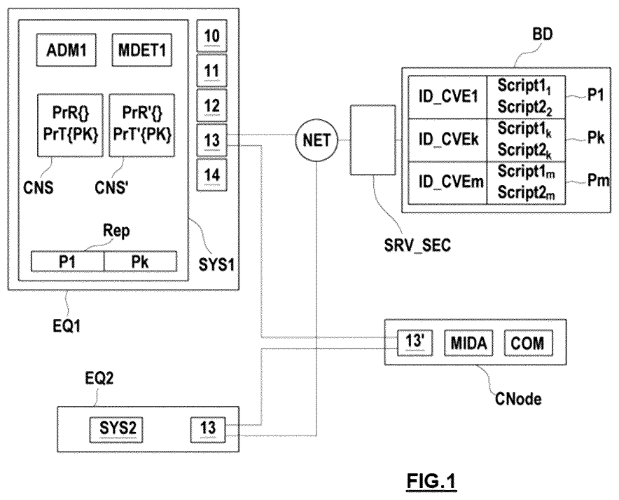

FIG. 1 represents one particular embodiment of the invention in which the detection and identification methods are implemented respectively by computers EQ1-EQ2 and a security management device CNode. In this embodiment, the security management device CNode has the hardware architecture of a computer server.

In this example, the invention is carried out for two computers EQ1 and EQ2, but the invention does not limit the number of computers. It can also be applied to a single computer or any number of computers, for example in a computer stock.

For the sake of clarity, the details of the computer EQ2 are not detailed in [FIG. 1], but the latter includes, like the computer EQ1, the components making it possible to implement the vulnerability exploitability detection method within the meaning of the invention.

The computers EQ1 and EQ2 include in particular a processor 10, a random access memory 11 of the RAM type, a read-only memory 12 of the ROM type, communication means 13 and a non-volatile rewritable memory, for example a hard disk 14.

Each computer EQn includes a software system SYSn. In this example, the software system SYS1 of the computer EQ1 includes:
a detection module MDET1 in accordance with the invention;
an administration tool ADM1 associated with administrator level rights;
a first combination CNS of namespaces with which a basic process PrR is associated, i.e. the first process created in this namespace combination;
a second namespace combination CNS′ with which a basic process PrR′ is associated; and
a directory Rep for recording detection programs P1, Pk, Pm, and on which the programs P1 and Pk are recorded.

The test processes PrT and PrT′ executing the program Pk in their respectively associated namespace combinations CNS and CNS' are created during an implementation of the detection method.

The security management device CNode is provided with means for communication 13′ with the computers EQ1 and EQ2 and with a module COM for communication with a user, for example an administrator of the set of computers EQ1-EQ2.

The security management device CNode also includes an identification module MIDA in accordance with the invention.

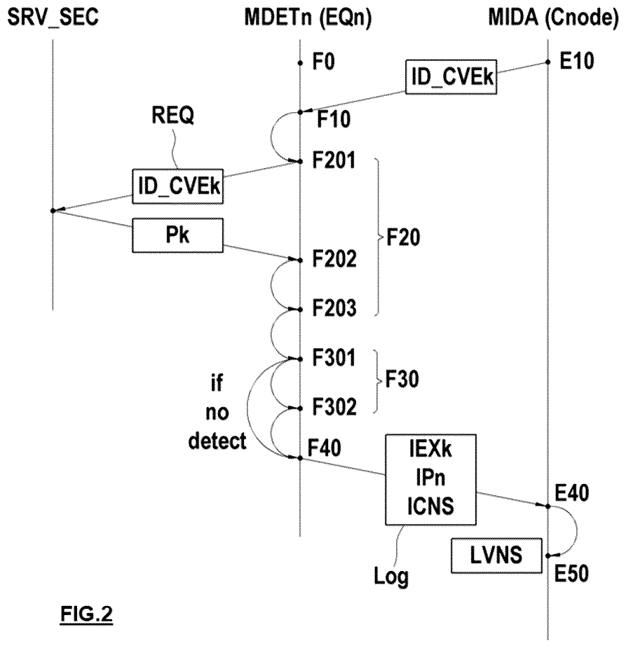

FIG. 2 represents on a flowchart one embodiment of the steps of a detection method and of an identification method carried out jointly by the module MDETn of the computer EQn and the module MIDA of the security management device.

In the example represented in [FIG. 2], the implementation of the detection method by a single computer is represented. Such an example on a single computer EQn is represented for the sake of simplicity but is in no way limiting of the invention. Particularly, the detection and identification methods can be implemented for several computers in parallel.

The module MIDA sends and receives signals or messages via the aforementioned communication means 13′. The module MDETn sends and receives signals or messages via the aforementioned communication means 13.

The computers EQ1 and EQ2 are configured to be able to communicate with a security server SRV_SEC via a communication network NET. This security server SRV_SEC includes a database BD. This database BD includes a set of identifiers IF_CVE1, ID_CVEk, and ID_CVEm of vulnerabilities, each identifier being respectively associated with a detection program P1, Pk or Pm configured to produce an indicator of the exploitability of a vulnerability, when the corresponding detection program is executed by a test process within the meaning of the invention.

The detection program Pk is for example directly sent by the server SRV_SEC to a computer EQn in the form of an executable program, or is, in another example, sent in the form of a description file then transformed into an executable file by the computer.

A vulnerability identifier ID_CVEk is for example of the form CVE-AAAA-IIII, where AAAA is the year of publication and IIII a unique number.

In the embodiment represented in [FIG. 2], the steps of the detection methods carried out by the module MDETn of the computer EQn are as follows:
identifying F0 combinations CNS-CNS' of namespaces and associated reference processes PrR-PrR′;
receiving F10 an identifier ID_CVEk of the vulnerability CVEk from the security management device CNode;
installing F20 a detection program Pk of the exploitability of the vulnerability CVEk, this installation comprising the sub-steps of:
   (i) sending F201 to the server SRV_SEC a request REQ comprising the identifier ID_CVEK;
   (ii) receiving F202, from the server SRV_SEC, the program Pk in response to the sending F201;
   (iii) recording F203 the program Pk in a directory Rep of the software system SYSn of the computer EQn;
initializing F30 a test process PrT in the same namespace combination CNS as the reference process PrR, and executing the program Pk by the test process PrT; and
sending F40, to the device CNode, a Log signal including an identifier IPn of the computer EQn, an identifier ICNS of the namespace combination CNS and an indicator IEXk of the exploitability of the vulnerability CVEk produced during the execution of the program Pk.

In this embodiment, the program Pk comprises instructions for the implementation of:
(i) a detection F301 of means for exploiting the vulnerability CVEk among resources, these resources being those assigned to the process which will execute this program Pk (test process within the meaning of the invention); and
(ii) a test F302 of exploitability of the vulnerability CVEk if such means are detected.

In this embodiment, and jointly, the module MIDA of the device CNode carries out the following steps according to one embodiment of the identification method:
sending E10 the identifier ID_CVEk to the computer EQn;
receiving E40 the Log signal from the computer EQn; and
adding E50 the signal in a list.

In one embodiment, the steps of initializing a test process F30 and of sending F40 by the computer EQn are repeated or performed in parallel for one or more other namespace combinations.

Particularly, in one embodiment, these steps F30 and F40 are performed for all the namespace combinations CNS-CNS' identified during step F0. In one particular mode of implementation of the invention in the context of a Linux operating system (registered trademark), a namespace combination per container is typically obtained.

In one embodiment, the namespace combinations identified are all the namespace combinations accessible via administrator-level rights of the computer EQn, these rights being provided by the module ADMn of the computer.

In one embodiment, these namespace combinations are obtained from obtaining the list of namespaces and the associated processes, accessible via administrator rights. For each namespace thus obtained, a single process, among the processes associated with this namespace, is selected as a reference process. For each selected reference process, the different namespaces associated with this process are identified. As explained above, the different namespaces associated with a process form the namespace combination with which this process is associated. Consequently, the namespace combinations and the reference processes respectively associated with these combinations are thus identified.

In one embodiment, each reference process PrR-PrR′ of a namespace combination CNS-CNS′ is the basic process of this combination, i.e. the first process created in this combination.

The basic process of a namespace can for example be identified using the command Isns in the case of a Linux system.

In the remainder of the description, the step of initializing F30 a test process PrT from a reference process PrR associated with a combination CNS is described in one embodiment. This step makes it possible to detect the exploitability of the vulnerability CVEk in the namespace combination CNS. Particularly, step F30 makes it possible to indicate whether the resources allocated to the processes of this combination CNS make it possible to exploit the vulnerability CVEk.

The test process PrT is initialized in the same namespace combination CNS as the reference process PrR. In one embodiment, the test process PrT is created such that it has the same environment variables as the reference process. For this purpose, the test process PrT is for example created as identical to the reference process, and thus generally inherits its environment variables.

For example, in a Linux system, the test process PrT is initialized with the function fork( ) applied to the reference process.

The test process PrT executes a detection program Pk that makes it possible to detect the exploitability of the vulnerability CVEk. In one embodiment, this program is composed of two parts.

The first part Script1ₖ, whose execution corresponds to step F301, checks whether the test process has the means for implementing an attack exploiting the vulnerability CVEk. These means correspond, among other things, to the resources isolated by the namespace combination CNS as well as the resources made accessible by the environment variables of the test process PrT.

Even if such means are present, the vulnerability may not be effectively exploitable. For example, security programs can be set up in the namespace combination CNS, such that an attack aimed at exploiting the vulnerability CVEk would be blocked. Whether or not such an attack is blocked, in other words the effective exploitability of the vulnerability, is determined by the second part of the detection program Pk.

The second part Script2ₖ of the program Pk, whose execution corresponds to step F302, tests the exploitability of the vulnerability CVEk. This part aims to exploit the vulnerability similarly to an attack, but without harmful consequences on the computer EQn.

The example of the vulnerability CVE-2021-3156 makes it possible to illustrate the execution of a detection program. This vulnerability affecting the sudo command is particularly critical given that sudo is used in a wide variety of environments. When a command is sent with sudo, the arguments of the command are first concatenated and the metacharacters are escaped with a backslash (for example, “\” becomes “\\”). When a special character, for example [, {, (, \ ou \hat{ }, is read as a normal character and not as a special character, it can be preceded by a backslash \. This is called escaping a character.

Particularly, the escape described here is not performed when sudo is executed via the symbolic link sudoedit -s. As a result, if an argument of the sudoedit command ends with a single backslash, the arguments not being escaped by sudo, the program will copy characters outside the limits of the memory buffer, which will result in a buffer overflow.

Annexes 1 and 2 correspond respectively to the first and second parts Script1ₖ and Script2ₖ of the detection program Pk in the case where the vulnerability CVEk is the vulnerability CVE-2021-3156. In this example, the detection program Pk is coded in bash language, which in no way represents a limitation of the invention. The invention makes it possible to use any programming language allowing those skilled in the art to code a detection program in accordance with the invention.

The execution of the code Script1ₖ in the Annex 1 checks for the presence of the symbolic link sudoedit for the execution of the binary sudo and records a message “Might be vulnerable” in an “interface” file if this presence is detected.

The execution of the code Script2ₖ in the Annex 2 launches the execution of the “exploit” file which corresponds to the use of the sudoedit command with a single backslash. If this execution fails, for example because of a security program blocking any use of the sudoedit command with a backslash, no message is produced. Otherwise, a message “Vulnerable” is recorded in the “interface” file.

Following the execution of the detection program Pk, the file “interface” contains an indicator IEXk of the exploitability of the vulnerability CVEk. If this indicator IEXk contains the message “Might be vulnerable” but does not contain the message “Vulnerable”, then it indicates that means to exploit the vulnerability CVEk are available to the processes of the namespace combination CNS, but that this vulnerability is not actually exploitable. If the indicator IEXk contains “Vulnerable”, then it indicates that the vulnerability CVEk is actually exploitable, and allows deducing that such a vulnerability must be addressed, for example by installing an additional security program, by adding a network protection beforehand, or by disabling the vulnerable functionality beforehand. If the indicator IEXk does not contain either of the messages above, then it indicates that the means for exploiting the vulnerability CVEk are not accessible to the processes of the namespace combination CNS.

Furthermore, the indicator IEXk contains information that identifies the tested vulnerability CVEk, for example the identifier ID_CVEk. This information can in particular be placed on the header in this indicator.

It should be noted that the example above in no way limits the possible contents of an exploitability indicator in accordance with the invention. Any content giving a clear indication on the exploitability of the vulnerability can be chosen by those skilled in the art.

In another example of vulnerability, the attack vector is of the network type. In other words, an attack exploiting this vulnerability is sent, from the network, to the IP address used by the process. Such an attack vector can be reproduced locally with the second part of the detection program by sending the network traffic on the local IP address 127.0.0.1.

The exploitability indicator IEXk as well as an identifier IPn of the computer EQn and an identifier ICNS of the namespace combination CNS are sent in the form of a Log signal, during step F40, to the security management device CNode.

The Log signal is then received by the module MIDA of the security management device CNode, which adds it to an LVNS list.

In one embodiment, the steps described above are performed in parallel for a plurality of namespace combinations in each of these computers.

Furthermore, in one embodiment, the steps described above are set up for a plurality of vulnerabilities CVE1-CVEm and their corresponding detection programs P1-Pm.

The LVNS list thus constructed indicates in which namespace combinations and in which computers different given vulnerabilities can be exploited. This list then constitutes a mapping of the vulnerabilities on a computer stock. It allows a central administrator to manage the security of the computer stock. In particular, the central administrator can, from the LVNS list, determine in which namespaces to install security programs.

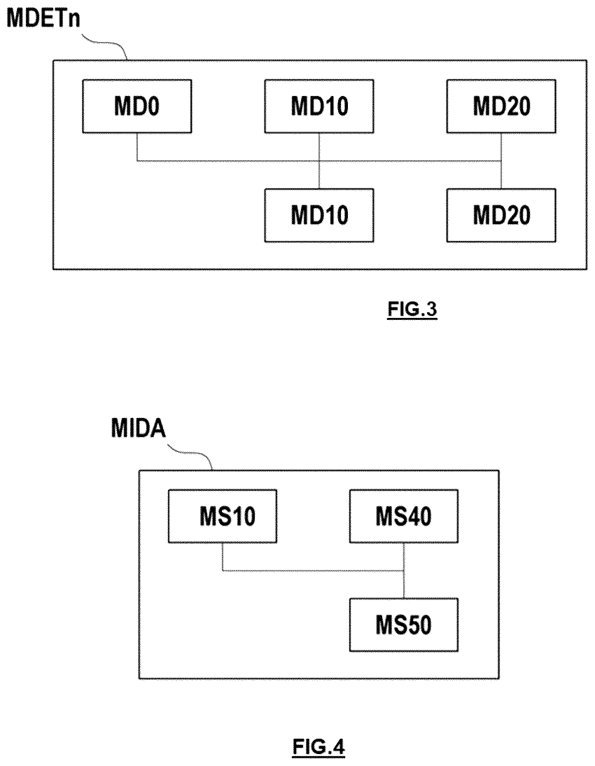

FIG. 3 represents the functional architecture of a module MDETn for detecting the exploitability of a vulnerability, in accordance with one particular embodiment of the invention. It includes:
a submodule MD0 for identifying a plurality of namespace combinations and the respectively associated reference processes;
a submodule MD10 for receiving an identifier of a computer vulnerability;
a submodule MD20 for installing a program for detecting the exploitability of a vulnerability;
a submodule MD30 for creating a test process executing a program for detecting the exploitability of the vulnerability producing an indicator of this exploitability;
a submodule MD40 for sending, to a security management device, a signal comprising this indicator.

FIG. 4 represents the functional architecture of a module MIDA for identifying the exploitability of a vulnerability in a namespace combination CNS of a computer EQn, in accordance with one particular embodiment of the invention. It includes:
a submodule MS10 for sending an identifier of a computer vulnerability;
a submodule MS40 for receiving a signal comprising an indicator IEXk of the exploitability of the vulnerability, an identifier ICNS of the combination CNS and an identifier IPn of the computer EQn;
a submodule MS50 for recording the signal in a list.

```
  [Annex. 1]
  ret=$(which sudoedit)
if [ ! −z $ret ]
then
  echo ″Might be vulnerable to $CVEID″>>interface
fi
  [Annex. 2]
  If [ $(echo ″pwd″] ./exploit) = $(pwd) ] ; then ;
  echo ″Vulnerable″ >> ${interface}; fi
```

1. A detection method implemented by a computer for and comprising:
detecting the exploitability of a computer vulnerability in a set of processes associated with a namespace combination, said method detecting including, for a reference process of said set:
initializing, from the reference process, and executing a test process associated with said combination and executing a detection program, the execution of said program producing an indicator of the exploitability of said vulnerability in said set of processes; and
sending to a security management device at least one signal comprising said indicator.

2. The detection method according to claim 1 wherein said reference process is a basic process of said combination.

3. The detection method according to claim 1 wherein the execution of the detection program includes:
a determination of a presence of one or more means for exploiting said vulnerability in an environment defined by at least said namespace combination and at least one environment variable of said reference process; and,
in response to one or more said exploitation means being detected:
a test of exploitation of said vulnerability with this or these exploitation means.

4. The detection method according to claim 1 including:
receiving, from said security management device, an identifier of said vulnerability;
installing, in said computer, said detection program corresponding to said identifier.

5. The detection method according to claim 4 wherein said installing includes:
sending, to a security server, a request including said identifier of the vulnerability;
receiving, in response to the request, said detection program.

6. The detection method according to claim 1, wherein said computer comprises a program for protection against the exploitation of said vulnerability and wherein said protection program is neutralized during the execution of said detection program.

7. The detection method according to claim 1 wherein said initialization and sending steps are carried out for each of the reference processes associated with a plurality of namespace combinations.

8. An identification method implemented by a security management device, to identify the exploitability of a computer vulnerability in at least one computer, said method including-steps of:
receiving, from said at least one computer, a signal comprising an indicator of the exploitability of said vulnerability in a set of processes associated with a namespace combination of said at least one computer; and
adding said signal to a list.

9. The identification method according to claim 8, wherein the security management device performs at least one action among:
installing at least one security program in at least one namespace;
addressing said vulnerability;
disabling a vulnerable functionality;
implementing a mitigation policy.

10. A computing device comprising:
at least one processor; and
at least one non-transitory computer readable medium comprising instructions stored thereon which when executed by the at least one processor configure the computing device to detect exploitability of a computer vulnerability in a set of processes associated with a namespace combination, the detecting including, for a reference process of said set:
initializing, from the reference process, and executing a test process associated with said combination and executing a detection program, the execution of said program producing an indicator of the exploitability of said vulnerability in said set of processes; and
sending, to a security management device, at least one signal comprising said indicator.

11. A security management device, comprising:
at least one processor; and
at least one non-transitory computer readable medium comprising instructions stored thereon which when executed by the at least one processor configure the security management device to identify exploitability of a computer vulnerability in at least one computer, said identifying including:
receiving, from said at least one computer, a signal comprising an indicator of the exploitability of said vulnerability in a set of processes associated with a namespace combination of said at least one computer; and
adding said signal to a list.

12. A non-transitory computer readable medium having stored thereon instructions which, when executed by a processor, cause the processor to implement the method of claim 1.

13. (canceled)
